(19) United States
(12) Patent Application Publication
(10) Pub. No.: US 2005/0169110 A1
(43) Pub. Date: Aug. 4, 2005

(54) Personalized alarm clock

(76) Inventors: Joseph J. Mazzilli, Bayside, NY (US); Edward Barbini, Culver City, CA (US)

Correspondence Address: LAW OFFICE OF RICHARD B. KLAR, 28 East Old Country Road, Hicksville, NY, 11801, US

(21) Appl. No.: 10/768,981

(22) Filed: Jan. 31, 2004

(51) Int. Cl. G04C 23/00

(52) U.S. Cl. 368/73

(57) ABSTRACT

A personalized alarm clock system is provided for awaking a user to his or her selected favorite video and/or audio footage. The personalized alarm clock system comprises an alarm clock; a display housed within said alarm clock; and one or more speakers housed within said alarm clock. The personalized alarm clock further comprises a removably attachable video/audio data source having the user's favorite video footage with audio thereon. The removable video/audio data source attaches to the alarm clock to input the user's favorite video footage with audio into the alarm clock to be played on the display and/or emitted through the one or more speakers.

### BACKGROUND OF THE INVENTION

1. Field of the Invention

The present invention relates to alarm clocks. In particular, the present invention relates to a personalized alarm clock system having a display monitor and wherein the user is awaken when the preset alarm time has been reached, with his or her selected favorite video footage, video footage with audio and/or audio information input into the alarm clock.

2. Prior Art

Alarm clocks have been in use for years. Typically, a conventional alarm clock allows the user to program the clock to sound an alarm at a specific time. However, conventional alarm clocks are not designed to awaken a user, when a preset alarm time has been reached, with the user's very own selected favorite video footage, video footage with audio and/or audio information input to the alarm clock.

Examples of patented clock devices include U.S. Pat. No. 4,659,231 to Barkouki; U.S. Pat. No. 4,906,982 to Gwynn; U.S. Pat. No. 5,097,429 to Wood et al.; U.S. Pat. No. 4,430,005 to Nishimura; U.S. Pat. No. 4,302,752 to Weitzler; U.S. Pat. No. 4,698,783 to Nishimuro et al.; U.S. Pat. No. 5,706,258 to Poe et al.; U.S. Pat. No. 5,511,046 to Vanderpal; U.S. Pat. No. 5,444,673 to Mathurin; U.S. Pat. No. 4,601,584 to DeWolf et al.; U.S. Pat. No. 4,512,667 to Doulton et al.; U.S. Pat. No. 4,276,541 to Inoue et al. which are all illustrative of such prior art.

While these devices may be suitable for the particular purpose to which they address, they are not as suitable for awaken a user, when a preset alarm time has been reached, with his or her selected favorite video footage, video footage with audio and/or audio information input into the alarm clock. Conventional alarm clock devices simply do not play customized and/or prerecorded video footage and/or audio information in response to an alarm event.

Other electronic devices which have alarm capabilities are known in the art. For instance, U.S. Pat. No. 6,427,078 B1 to Wilska et al. relates in relevant part to a device for personal communication, data collection and data processing, which is a small-sized, portable and hand-held work station comprising a data processing unit; a display; a user interface; a number of peripheral interfaces; at least one memory unit; a power source, such as a battery; and an application software. The device also comprises a camera unit. The camera unit comprises a camera, such as a semiconductor camera, and optics connected thereto, which are placed in the housing of the device. Alternatively, the camera unit may be fitted on a PCMCIA card which is connected to the PCMCIA slot of the device. Further, U.S. Pat. No. 2003/0045955 A1 to Janik relates in relevant part an audio converter device and method for using the same. In one embodiment, a system used to perform the functions of an alarm clock for use with a stereo system is described. The system includes an alarm clock controller, which includes a wireless LAN transceiver and the functional components required to allow the alarm clock remote controller to operate as a node on the wireless LAN. The user can input a wake-up time into a PC using the alarm clock controller, which is sent, via a LAN communication link to a digital audio converter. The digital audio converter may include a switched AC power conversion function that is used to switch on a stereo receiver at the specified time in order to wake up the person sleeping in the room.

As with conventional alarm clocks, the above electronic devices are also not designed to awaken a user, when a preset alarm time has been reached, with his or her selected favorite video footage, video footage with audio and/or audio information input to the alarm clock.

### SUMMARY OF THE INVENTION

It is therefore a principle object of the present invention to provide a personalized alarm clock system for awakening a user to his or her selected favorite video footage, video footage with audio.

It is another object of the present invention to provide a personalized video alarm clock system, which features a color LCD displays monitor for displaying digitally transmitted video footage customized to the user's liking or prerecorded video clips of various interests and genres.

It is another object of the invention to provide a personalized alarm clock which allows the user to record and save his or her favorite videos, allowing them to be played at such time when the preset alarm time has arrived.

It is another object of the present invention to provide a personalized alarm clock which allows the user to choose to wake up to their own recorded video track of their children or family, or to a video track prerecorded by their own favorite Hollywood celebrity, singer, sports star, among other choices.

It is another object of the present invention to provide a personalized alarm clock which allows the user to store, transfer and share their digital videos, voice files and more.

It is an object of the present invention to provide the user with a simple way to update, modify or replace the current video/and/or audio clips with new video/audio clips to provide variety to the user.

It is a further object of the present invention to provide a personalized alarm clock which makes getting up early in the morning for work or school an enjoyable experience.

Other objects and advantages of the present invention will become obvious to the reader and it is intended that these objects and advantages are within the scope of the present invention.

In accordance with the present invention, a personalized alarm clock system is provided for awaking a user to his or her selected favorite video and/or audio footage. The personalized alarm clock system comprises an alarm clock; a display housed within said alarm clock; and one or more speakers housed within said alarm clock. The personalized alarm clock further comprises a removably attachable video/audio data source having the user's favorite video footage with audio stored thereon. The removable video/audio data source attaches to the alarm clock to input the user's favorite video footage, video footage with audio, and/or audio information into the alarm clock to be played on the display and/or emitted through the one or more speakers.

The display is preferably a color liquid crystal display monitor having a backlit display with brightness control for easy viewing. In another preferred embodiment of the present invention, the personalized alarm clock system, further comprises a CD player and a radio.

### BRIEF DESCRIPTION OF THE DRAWINGS

FIG. 1 is an enlarged frontal view of the first embodiment of the personalized alarm clock of the present invention, wherein the alarm clock has a square shaped housing;

FIG. 2 is a frontal view of the first embodiment of the personalized alarm clock of the present invention, wherein the alarm clock has a square shape housing;

FIG. 3 is a frontal view of the first embodiment of the personalized alarm clock of the present invention, wherein the alarm clock has a circular shaped housing;

FIG. 4 is a frontal view of the first embodiment of the personalized alarm clock of the present invention, wherein the alarm clock has a rectangular shaped housing;

FIG. 5 is an upper perspective view of the first embodiment of the personalized alarm clock of the present invention, wherein the personalized alarm clock has a housing constructed of a flat panel design;

FIG. 6 is an enlarged frontal view of the second embodiment of the personalized alarm clock of the present invention, wherein the alarm clock has a circular shaped housing;

FIG. 7 is a frontal view of the second embodiment of the personalized alarm clock of the present invention, wherein the alarm clock has a square shaped housing; and

FIG. 8 is a block diagram of electrical components of the first and second embodiments of the present invention.

### DETAILED DESCRIPTION OF PREFERRED EMBODIMENTS

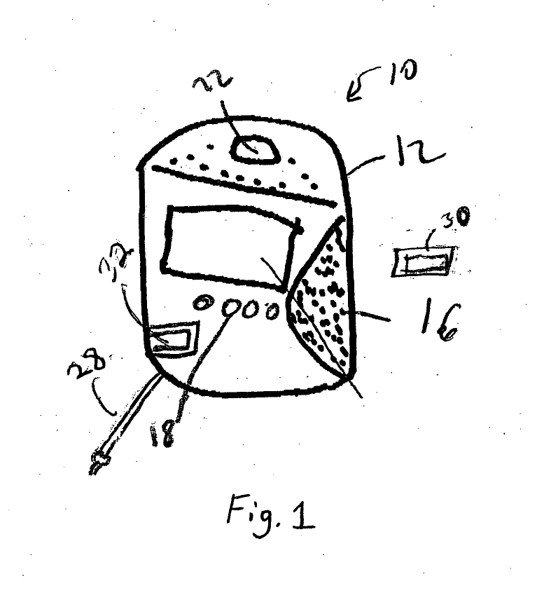

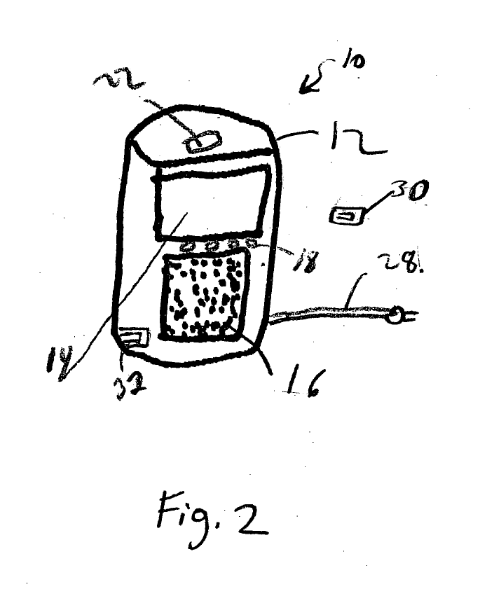

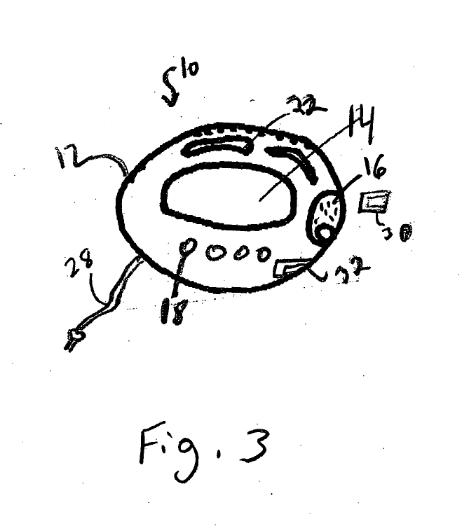

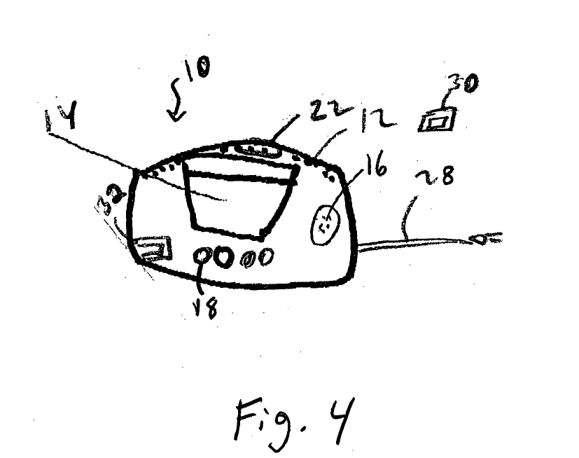

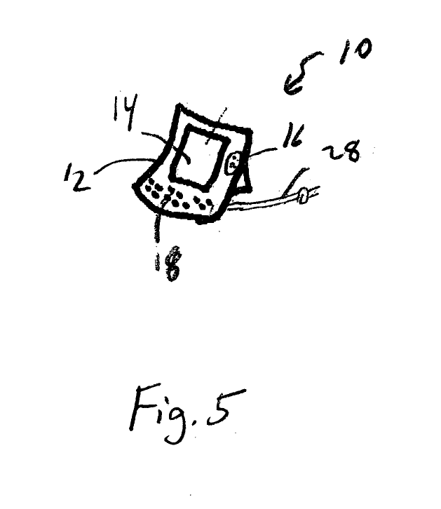

Referring to a preferred embodiment of the present invention, depicted in FIGS. 1-5 and 7, a personalized video alarm clock is generally referred to generally at 10 for playing , at the preselected alarm time, video footage customized to the users liking or prerecorded video clips of Hollywood celebrities, sport stars, music stars, family members, friends, etc. The embodiments set forth below serve only as examples of practicing the present invention and thus any type of alarm clock system which achieves the objectives of the present invention described herein is also considered to be encompassed within the scope of the presently claimed invention.

Moreover, the alarm clock of the present invention in addition to functioning as a personalized alarm clock, the alarm of the present invention may also function as a conventional alarm clock, if desired. It is also noted that the alarm clock of the present invention, may be used as an video footage and audio footage player without setting the alarm.

Turning to the first embodiment of the claimed invention (as illustrated in FIGS. 1-5 and 7), the personalized alarm clock 10 includes a housing 12, a display 14 positioned within the housing 12, one or more speakers 16 positioned within the housing 12 and a plurality of control buttons 18 positioned within the housing 12. The housing 12 is preferably a rigid structure. The housing 12 may be comprised of various shapes and designs that are aesthetically pleasing to consumers. The housing 12 may have various colors or may be transparent. Moreover, the housing 12 may also include one or more footings to support the housing 12 upon a surface such as a table.

Alarm clock 10 is also preferably provided with tuner dials, buttons or the like for selecting the radio station and adjusting the volume of the sound being emitted from the alarm clock 10. Also, alarm clock 10 is also preferably includes a delay input button 22, such as a snooze bar to cause a delay in either the playing of selected video footage on the display, sounding of the alarm buzzer or the playing of the digital audio, depending on which “alarm mode” has been selected. The user programs control unit 60 for setting the time increments for the snooze mode using control buttons to select the amount of time or time increment in which the replaying of the alarm mode is delayed.

Further, the alarm clock 10 includes a plurality of alarm control members or control switches 24 switches for selecting the alarm mode (e.g. video, audio, buzzer, radio etc.), selecting the radio band, e.g. am or fm and for turning the alarm clock radio and/or alarm on or off. The alarm mode includes a “video/audio mode” for playing customized or prerecorded video footage (e.g. Hollywood celebrity, music stars, family member, friends, etc) on display 14, and/or for playing digital sounds (e.g. celebrity or family member's voices, songs, etc.) through speakers 16, a “buzzer mode” for sounding a buzzing or beeping alarm sound, and a “radio mode” for playing a selected radio station upon reaching the preselected alarm time. In addition, alarm clock 10 may also be provided with multiple “alarm modes” to awaken a user to a combination of two or more of the above “alarm modes” upon occurrence of the alarm event.

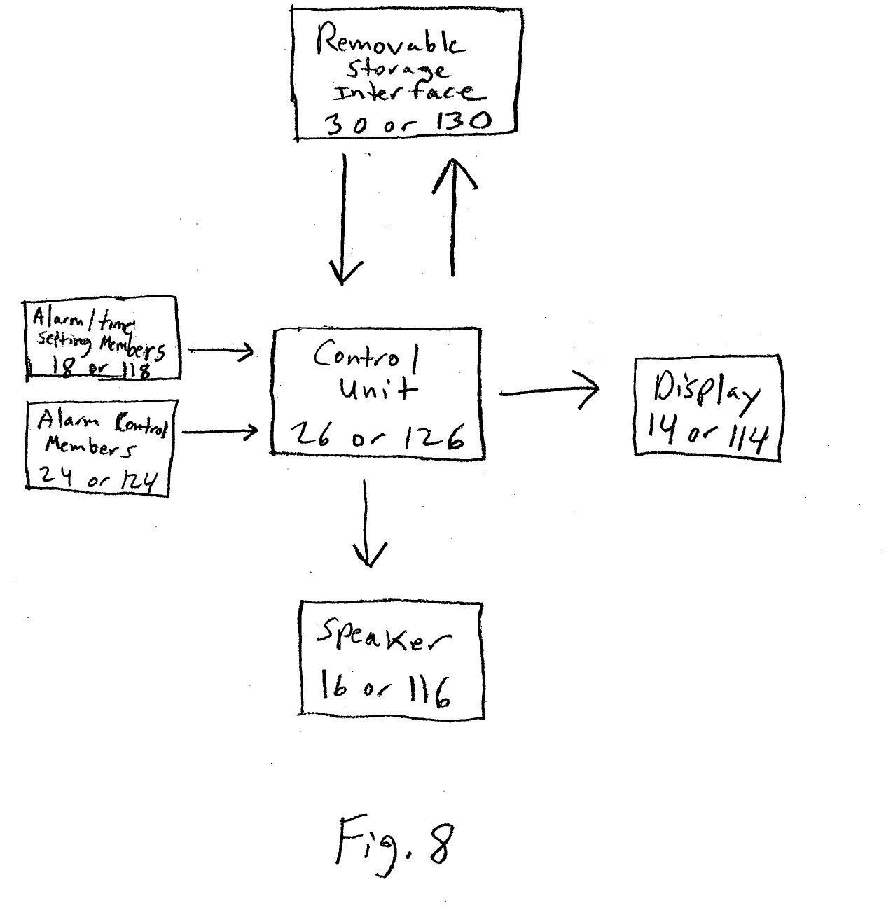

As illustrated in FIG. 8, the alarm clock 10 further comprises a control unit 26 or microprocessor, CPU or the like positioned within the housing 12 and electrically connected to the alarm/time setting members or control buttons 18, display 14 and the speaker 16. The control unit 26 is programmable and capable of storing programmed items such as the current time and alarm settings. Namely, the user may program the control unit 26, using the control buttons 18 (As shown in FIGS. 1-5 and 7) for setting the current time on the alarm clock 10, setting the alarm time or times, setting the a snooze mode by presetting the time increments for which the playing of the alarm mode is delayed, and for various other settings. The control unit 26 receives electrical power either from a battery source or a power cord 28. Control unit 26 controls the display 14 including the current time and the alarm settings to be displayed to the user. Control unit 26 also determines when the pre-set alarm time has been reached, which “alarm mode” (programmed on the control unit 26 by alarm control switches 24) has been selected, and controls display 14 and speakers 16 accordingly. Specifically, if “video/audio mode” is selected by the user as the alarm mode, once the control unit 26 determines that the preset alarm time has been reached and that the “video/audio mode” has been selected, the control unit 26 controls the transfer of the selected video footage and/or audio footage information input into the alarm clock. The above video and/or audio information is then played on said display and/or emitted through said one or more speakers, depending upon whether the information is video footage and video footage with audio.

The compatible video storage, capture and compression standards and formats of the present invention are described below. These capture and compression standards and formats of the present invention include but are not limited to: PCMCIA or PC cards, CD, audio CD-R, audio CD-RW (5 and 3 inch), DVR, DVD, DVD-R, MP3 (music files), MPEG (movie files), MPEG-1, MPEG-4, JPEG (picture files), wavelets, the ADS platform, web cam-dims, MUSICAM, random frame acess, NTSC, AVI, WMN, Lector multimedia, and/or any image and/or video compression, decompression and storage formats, whether or not devised or conceived, amongst any and all available video storage methods, techniques or processes.

As mentioned above and illustrated in the first preferred embodiment illustrated in FIGS. 1-4 and 7, personalized video footage clips and audio data used by the alarm clock 10 may be obtained, for example from a removable attachable video/audio data source such as an external PCMCIA card 30 or PC card . The preferred video footage and sound data is downloaded onto the card via an external electronic device such as a digital camera or PC computer. In addition, other external electronic devices which utilize PCMCIA cards or the like for storing captured video images and sound data, know in the art, may also be used in accordance with the present invention. Suitable PCMCIA cards or PC cards for use with the present invention include but are not limited to the following: ATA Flash (brand name: ScanDisk Industrial Grad), Compact Flash (brand names: Lexar Media CompactFlash, SanDisk Compact Flash), SRAM (brand names: Envoy Data Corporation, Centennial Rechargeable Card), Linear Flash (brand names: Envoy Data Corporation, Intel Centennial), IBM Microdrive (brandname: IBM), SmartMedia (brand name: Lexar), Hard Disk Cards (brand name: Toshiba), Secure Digital (brandname: Lexar), Memory Stick (brandnames :Lexar Media, Sony), MultiMedia (brand names: Lexar) and JumpDrive (brand name: Lexar) among others.

Once the user has their preferred video images and sounds stored on the card 30, they would then remove the card 30 from PCMCIA card slot of the external device, such as from the digital camera or the PC computer. This PCMCIA card 30 with the above stored information, i.e. video images and/or sound data would then be inserted in PCMCIA card slot 32 of alarm clock 10. The PCMCIA card 30 once inserted into card slot 32 is operatively connected to control unit 26. This operative connection between PCMCIA card 30 and the control unit 26, allows the control unit 26 upon its determination that the pre-set alarm time has been reached and that “video/audio mode” alarm mode has been selected, the control unit 26, to read the information, e.g. video footage and/or sound stored on card 30. If only video footage were contained on PCMCIA card 30 then this footage would read by control unit 26 and played on display 14 to awaken the user. If card 30 also contained corresponding sound to go along with this footage, this corresponding sound would be emitted through speakers in the LCD display 14 and through speakers 16. Similarly, if the PCMCIA card 30 contained only sound data such as voices or songs, the control unit would read this sound data and have the sound or sounds emitted from speakers 16 and also speakers in display 14, if desired.

Besides the PCMCIA method mentioned above, alarm clock 10 can also receive video images and sound in several ways including but not limited to providing alarm clock 10 with input ports or the like in order to be able to connect alarm clock 10 directly with external devices such as digital cameras and PC computers, via for example cables, for the alarm clock 10 to receive images and/or sound from these external devices. This video and audio could then be stored in control unit 26 and/or in an additional RAM chip provided within the alarm clock 10. This information could then be later accessed to awaken the user in the same manner as described above for the PCMCIA card 30.

Moreover, if the user which to modify or enhance the information stored on either the RAM chip, control unit 26 or on the PCMCIA card 30, the user could edit this information in many different ways, including but not limited to using a PC computer, digital camera, camcorder or other external electronic device which is connected to the alarm clock 10. If the user wished to change the video footage or sound data on the alarm clock 10 completely, they could either erase the information from the control unit 26 and/or RAM chip and transfer or download selected new video footage and/or sounds via the above mentioned PCMCIA card 30 method or via external devices or other methods known by those skilled in the art to achieve the objectives of the present invention.

Display 14, as shown in FIGS. 1-5 and 7 is positioned within a front portion of the housing 20 and is operatively connected to the control unit 26 or microprocessor for receiving video image and/or audio data. The display 14 is preferably a color LCD monitor. The display 14 is constructed to display 30 all times of the day in conventional time (am, pm) or military time. The display 14 is also capable of displaying other items commonly found upon a conventional clock. Further, as mentioned above, display 14 also displays video footage or video clips which are either read by or stored within the alarm clock. As mentioned above, display 14 is preferably a color liquid crystal display (LCD) monitor with audio capability. Further, the display 14, preferably has a backlit display with brightness control as known in the art for easy viewing of the video footage played on the display 14. However, display 14 may be any video display or other image product, similar to a TV, but having less than, equal to, or superior visual quality, with or without a tuner, of any size or specification, providing video clips, including, but not limited to: monitor, panel, computer screen, broadcast media, active matrix, monochrome display adapter (MDA), LCD panel, composite video, CGA color graphics adapter, EGA enhanced Graphics Adapter, ECL (Sun and Apollo Monochrome), (Apple) Mac II/Quadra, (IBM) XGA/XGA-2/Super VGA Extended Graphics Array, VGA 640×480 31.5 kHz, 60/70 Hz, scalable VGA, VESA VGA (DDC) VGA=Video Graphics Adapter or Video Graphics Array, VESA (Video Electronics Standards Association), DDC (Display Data Channel), VESA Super VGA, VESA Video, 13W3 IBM PowerPC, Sun Color, SGI (Silicon Graphics), NeXT Color, Intergraph, PGA (Professional Graphics Array) (IBM)), VGA (9-Pin)/VGA=Video Graphics Adapter or Video Graphics Array, 8514/A, MCGA, S-video, SDI (Serial Digital Interface), SDTV (Standard Definition Television), SECAM (Acronym for Sequential Couleur A Menorie; the analog standard format used by France, Russia, the Middle East, Africa, and various European countries. Although SECAM is incompatible with NTSC and PAL standards, conversion between standards is possible), Source Monitor (the interface window of Adobe Premiere that displays clips to be edited), split screen, still frame, streaming video, subcarrier 9 a 3.58 MHz signal modulated by color signals and combined with luminance signals to produce an NTSC composite video signal), sync (short for synchronous, the signals used to synchronize the horizontal and vertical scans of a video signal and is usually accompanied by a subcarrier), or any parallel analog or digital component video interconnection, and/or similar or related terminology, allowing for observation on a screen, whether or not devised or conceived, among any and all available video transmission methods, techniques or processes.

Other features which are preferably provided with the alarm clock 10 of the present invention include a battery backup. A 9-volt battery, for example, provides power to the alarm clock during a power outage. Another preferred feature is a headphone jack located within alarm clock 10 for personal listening.

In using the alarm clock 10 of the present invention, first the user plugs the alarm clock 10 into a wall outlet via plug 28 to power the alarm clock 10. It is also noted that the clock 10 may also be powered via batteries. The user then programs the current time into the control unit 26 using the control buttons 18 in order to display the current time on display 14. If the user desires to be awoken via the alarm clock 10, he or she would set the time for the alarm to go off via using control buttons 18 to program control unit 26 and store the preset alarm time therein. He or she could also program a snooze option to allow himself or herself the possiblity of going back to sleep after the alarm went off and then being awoken again at a preselected time increment programmed into the control unit 26 via control buttons 18. Next, the user would determine whether he or she wanted to be awoken by a customized video and/or sound clip (e.g. of a family member), a prerecorded video and/or sound clip (e.g. of their favorite Hollywood celebrity, music star, sports star, etc.) or instead by a conventional alarm clock means such as the radio or by a beeping or buzzing sound.

For the sake of example, lets say the user decided to be awoken by a video clip with supporting audio sound of his son playing little league baseball. In this scenario, the user would have the above selected video/audio footage of his son input into the alarm clock and stored therein via, for example through use of a PCMCIA card 30, PC computer or other device known the art to achieve the objects of the present invention. When this video/audio clip was stored within the alarm clock, the user would then select the alarm mode “video/audio” via control switch 24. Subsequently, upon determination by control unit 26 that the pre-set alarm time has arrived and that the video/audio mode has been selected, control unit 26 would read the video/audio clip stored in the alarm clock 10. The control unit 26 would then have the video clip played on display 14 and the sound portion would be emitted through speakers 16 and speakers in display 14 to awaken the user. At this point the user could either watch the video clip and get out of bed or decide to go back to bed and sleep a bit longer. In the event, the user was not ready to wake up and instead would rather go back to sleep and be awaken again, he or she would hit the snooze bar 22 which would delay the playing of the selected video/audio clip for a predetermined amount of time. Further, if the user desired a new video and/or audio alarm message, as discussed he or she could constantly update or change their video/and audio clip for his alarm messages by erasing or replacing these video/and/or audio clips with new video/and/or audio clips by the methods described herein and by those know in the art which would be within the scope of the present invention

Finally, as mentioned above, this alarm clock 10 could also be used as a conventional alarm clock emitting standard sounds such as buzzing or beeping sounds or by playing a selected radio station to awaken the user. The alarm clock 10 could also be used as a regular radio having am/fm stations.

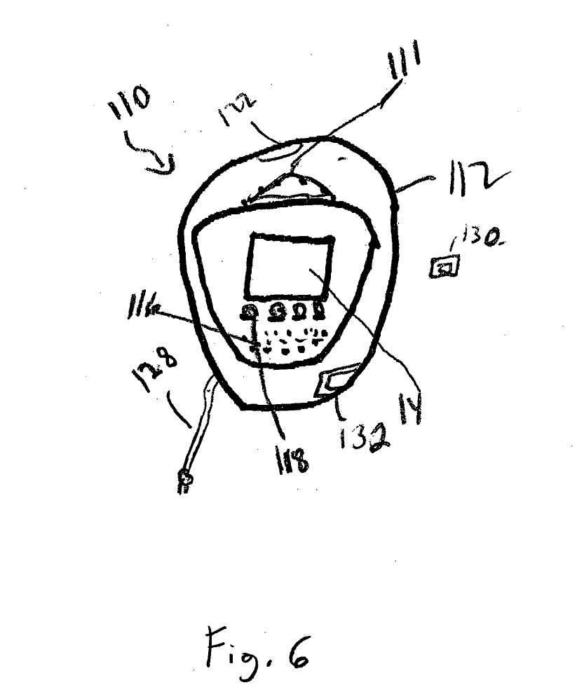

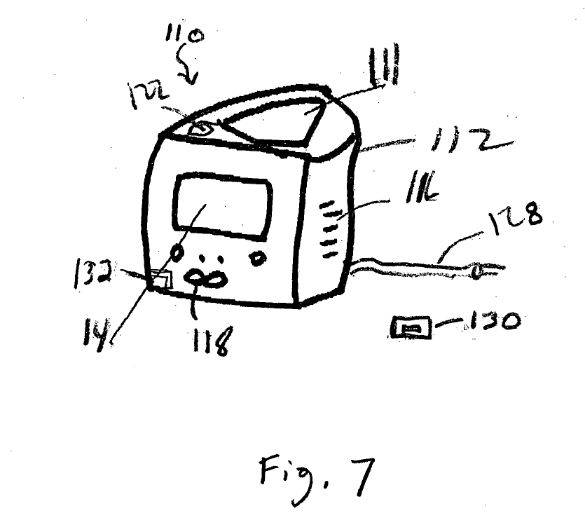

Now turning to a second embodiment of the present invention depicted in FIGS. 6 and 7, a personalized alarm clock is generally referred to a 110. This alarm clock 110 contains all of the elements of the alarm clock 10 of the first embodiment of the present invention, except that the alarm clock 110 of the second embodiment further includes a compact disc (CD) player 111. Namely, the alarm clock 110 of the second embodiment includes a housing 112, a display 114 positioned within the housing 112, one or more speakers 116 positioned within the housing 112 and a plurality of control buttons 128 and control switches 124 positioned within the housing 112 for programming the control unit 126. As with the first embodiment, alarm clock 110 also preferably includes tuner dials, buttons or the like and a snooze bar 122. Moreover, as with the first embodiment, alarm 110 also includes a data input area, such as a PCMCIA 132 or PC card slot (shown in FIGS. 6 and 7) for receiving a PCMCIA card 130 or PC card having selected video and/or audio clips saved thereon. Also, as mentioned in the first embodiment, other video/audio data input means for receiving selected video/and/or audio clips may be used in addition to or in lieu of the PCMCIA or PC card slot, such as input ports linking the alarm clock 110 to an external electronic device such as a PC computer, digital camera, camcorder, or other external electronic device known by one skilled in the art to perform the objects of the present invention. Another possible data input means for alarm clock 110 is through use of its CD player 111. Specifically, a CD may contain video and/or audio which may be activated upon occurrence of the preset alarm time.

In use, the personalized alarm clock 110 performs in exactly the same manner as the alarm clock 10 of the first embodiment, except that alarm clock 110 also contains a CD player 111. This CD player 111 provides an additional data input mode, wherein one can use a CD with selected video and/or audio clip stored therein. The control unit of alarm clock 110 could then read this stored video and/or audio data from the CD player, upon the occurrence of the preset alarm time and then the control unit could have the video displayed the on display 114 and have the audio emitted through speakers 116. In addition, the alarm clock 110 could also be used as a conventional alarm clock, CD player and/or as a radio.

Another embodiment of the present invention provides for the personalized alarm clock to optionally have a built in video camera so that the user can make a personalized video which can be displayed on the personalized alarm clock's screen.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A personalized alarm clock system for awaking a user to his or her selected favorite video and/or audio footage, comprising:
an alarm clock;
a display housed within said alarm clock;
one or more speakers housed within said alarm clock; and
a removably attachable video/audio data source having user's favorite video footage, video footage with audio, and/or audio information stored thereon, said removable video/audio data source attaches to said alarm clock to input the user's favorite video footage with audio into said alarm clock to be played on said display and/or emitted through said one or more speakers.

2. The alarm clock system of claim 1, further comprising a PCMCIA card slot located within said alarm clock.

3. The alarm clock system of claim 2, wherein said video/audio data source is a PCMCIA card.

4. The alarm clock system of claim 1, wherein said display is a color liquid crystal display monitor.

5. The alarm clock system of claim 4, wherein said color liquid crystal display monitor has a backlit display with brightness control for easy viewing.

6. The alarm clock system of claim 1, further comprising one or more input ports for receiving said selected favorite video and audio.

7. The alarm clock system of claim 6, wherein said video/audio data source comprises at least one electronic external device connected to said alarm through said one or more input ports, said external electronic device supplies said selected favorite video and audio footage to said alarm clock via said at least one input port to awaken said user upon occurrence of the preset alarm time.

8. The alarm clock system of claim 7, wherein said external electronic device is selected from the group consisting of: PC computer, digital camera, camcorder, digital camcorder, and cellular telephone.

9. The alarm clock system of claim 1, wherein said selected favorite video and/or audio footage is selected from the group consisting of: customized video/audio footage of said user's family, customized video/audio footage of said user's children, prerecorded video/audio of user's favorite hollywood celebrity, prerecorded video/audio of user's favorite singer, prerecorded video/audio of user's favorite music star, prerecorded video/audio of user's favorite sports star.

10. The alarm clock system of claim 1, wherein said user's favorite video footage, video footage with audio inputted into said alarm clock is be played on said display and/or emitted through said one or more speakers, upon the arrival of said preset alarm time.

11. The alarm clock system of claim 1, further comprises a CD player and a radio.

12. A personalized alarm clock system for awaking a user to his or her selected favorite video and/or audio footage, comprising:
a housing;
a removable video/audio data source which connects to a video/audio data access area positioned within said housing, said removable video/audio data source having user's favorite video footage, video footage with audio stored thereon;
a control unit positioned within said housing, said control unit is operatively connected to said video/audio data source;
a display positioned within said housing, said display is operatively connected to said control unit;
one or more speakers positioned within said housing, said one or more speakers is operatively connected to said control unit;
a plurality of alarm/time setting members for setting the current time of the alarm clock and for programming the control unit to store the current time, said plurality of alarm/time setting members positioned within said housing, said plurality of alarm/time setting members causes the control unit to display the current time on said display,
a plurality of alarm control members positioned within said housing, said plurality of alarm control members program an alarm mode or modes such as a video/audio alarm mode into the control unit; and
whereby when said control unit determines that the preset alarm time has arrived and that the video/audio alarm mode has been selected, the control unit will read said selected favorite video footage, video footage with audio and/or audio footage information stored on said video/audio data source and have this information played on said display and/or emitted through said one or more speakers, depending upon whether the information is video footage, video footage with audio, and/ audio information.

13. The alarm clock system of claim 12, wherein said data access area is a PCMCIA card slot located within said housing.

14. The alarm clock system of claim 13, wherein said video/audio data source means is a PCMCIA card.

15. The alarm clock system of claim 12, wherein said display is a color liquid crystal display monitor.

16. The alarm clock system of claim 12, wherein said color liquid crystal display monitor has a backlit display with brightness control for easy viewing.

17. The alarm clock system of claim 12, further comprising one or more input ports for receiving said selected favorite video and audio footage.

18. The alarm clock system of claim 17, wherein said video/audio data source means is at least one electronic external device connected to said alarm through said one or more input ports, said external electronic device supplies said selected favorite video and audio footage to said alarm clock via said at least one input port to awaken said user upon occurrence of the preset alarm time.

19. The alarm clock system of claim 18, wherein said external electronic device is selected from the group consisting of: PC computer, digital camera, camcorder, digital camcorder, and cellular telephone.

20. The alarm clock system of claim 12, further comprises a CD player and a radio.

21. The alarm clock of claim 12, further comprises a built in video camera so that the user can make a personalized video which can be displayed on the personalized alarm clock's screen.
